(19) United States
(12) Patent Application Publication
(10) Pub. No.: US 2026/0094827 A1
(43) Pub. Date: Apr. 2, 2026

(54) BATTERY

(71) Applicant: ZHUHAI COSMX BATTERY CO., LTD., Zhuhai (CN)

(72) Inventors: Yinghang Lin, Zhuhai (CN); Chunyang Liu, Zhuhai (CN)

(21) Appl. No.: 19/324,163

(22) Filed: Sep. 10, 2025

(30) Foreign Application Priority Data
Sep. 29, 2024 (CN) 202411374006.5

(51) Int. Cl. H01M 4/583; H01M 4/02; H01M 4/38

(52) U.S. Cl. CPC H01M 4/583; H01M 4/386; H01M 2004/021; H01M 2004/027

(57) ABSTRACT

A battery comprises a positive electrode plate and a negative electrode plate. The negative electrode plate comprises a negative electrode current collector and a negative electrode active material layer located on a surface on at least one side of the negative electrode current collector. The negative electrode active material layer comprises a negative electrode active material, and the negative electrode active material comprises graphite particles and silicon-carbon particles. The graphite particles comprise first graphite particles and second graphite particles. The particle size Dv50 of the first graphite particles is greater than that of the second graphite particles. The positive electrode plate comprises a positive electrode active material, and the positive electrode active material comprises a material with a chemical formula of LiₐNiₓCo_{y}Mn_{z}MₖO₂. The battery of the present disclosure can have high energy density, low expansion rate and excellent cycling performance.

### CROSS-REFERENCE TO RELATED APPLICATIONS

The present application claims priority to Chinese Patent Application No. 202411374006.5, titled “BATTERY,” filed on Sep. 29, 2024, the entire contents of which are incorporated herein by reference.

### TECHNICAL FIELD

The present disclosure relates to the technical field of batteries, and in particular relates to a battery.

### BACKGROUND ART

Silicon (Si) has a theoretical capacity per gram of 4200 mAh/g, which has obvious advantages in improving the energy density of the battery compared to the widely used graphite. However, the expansion rate of silicon reaches 300% when the battery is fully charged, which is much larger than the expansion rate of graphite (about 19%) when the battery is fully charged, greatly limiting the use of silicon materials in secondary batteries. In addition, when the positive electrode active material is a ternary material, the surface stability of the conventional silicon-containing negative electrode would also be readily affected, which is even more detrimental to inhibiting the expansion of the silicon negative electrode.

Therefore, it is very important to provide a battery with both high energy density and low expansion rate.

### SUMMARY

In order to overcome the aforementioned problems in the prior art, the present disclosure provides a battery. The battery of the present disclosure can have high energy density, low expansion rate and excellent cycling performance.

The present disclosure provides a battery. The battery comprises a positive electrode plate and a negative electrode plate; the negative electrode plate comprises a negative electrode current collector and a negative electrode active material layer located on a surface on at least one side of the negative electrode current collector; the negative electrode active material layer comprises a negative electrode active material, the negative electrode active material comprises graphite particles and silicon-carbon particles, and the graphite particles comprise first graphite particles and second graphite particles; the particle size Dv50 of the first graphite particles is greater than that of the second graphite particles; the positive electrode plate comprises a positive electrode active material, and the positive electrode active material comprises a material with a chemical formula of LiₐNiₓCo_{y}Mn_{z}MₖO₂, where 0.8≤a≤1.2, 0.8≤x≤0.95, 0<y<0.2, 0<z<0.2, 0≤k≤0.05, M comprises at least one of Al, Mg, Zr, B, Y, Sr, W, La, Ti, and Nb.

By means of the above technical solution, the present disclosure has at least the following advantages over the prior art:
(1) The battery of the present disclosure can effectively improve the kinetic performance of the negative electrode plate, while also reducing the cycling expansion of the electrode plate to achieve a small expansion rate in battery, thereby reducing the risk of deformation of the cell in the later stage of cycling.
(2) The battery of the present disclosure can avoid a significant decrease in the compacted density and capacity per gram of the electrode plates, so that the energy density of the battery is effectively improved.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein.

### BRIEF DESCRIPTION OF THE DRAWINGS

FIG. 1 shows the comparison diagram of the combined structures of the negative electrode active material particles of the present disclosure and the conventional negative electrode active material particles.

FIG. 2 shows a schematic SEM image of the surface of a conventional negative electrode plate in an example of the present disclosure.

FIG. 3 shows a graph of number particle size distribution curve of the second graphite particles in Example 1 of the present disclosure.

FIG. 4 shows a graph of number particle size distribution curve of the first graphite particles in Comparative example 1 of the present disclosure.

FIG. 5 shows a schematic SEM image (×5 K) of the surface of a negative electrode plate after rolling in Example 1 of the present disclosure.

FIG. 6 shows a schematic SEM image (×5 K) of the surface of a negative electrode plate after rolling in Comparative example 1 of the present disclosure.

FIG. 7 shows a schematic SEM image (×2.5 K) of the CP cross section of a negative electrode plate after rolling in Example 1 of the present disclosure.

FIG. 8 shows a schematic SEM image (×2.5 K) of the CP cross section of a negative electrode plate after rolling in Comparative example 1 of the present disclosure.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

The present disclosure provides a battery. The battery comprises a positive electrode plate and a negative electrode plate; the negative electrode plate comprises a negative electrode current collector and a negative electrode active material layer located on a surface on at least one side of the negative electrode current collector; the negative electrode active material layer comprises a negative electrode active material, the negative electrode active material comprises graphite particles and silicon-carbon particles, and the graphite particles comprise first graphite particles and second graphite particles; the particle size Dv50 of the first graphite particles is greater than that of the second graphite particles; the positive electrode plate comprises a positive electrode active material, the positive electrode active material comprises a material with a chemical formula of LiₐNiₓCo_{y}Mn_{z}MₖO₂, where 0.8≤a≤1.2 (for example, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19 or 1.2), 0.8≤x≤0.95 (for example, 0.8, 0.81, 0.82, 0.83, 0.84, 0.85, 0.86, 0.87, 0.88, 0.89, 0.9, 0.91, 0.92, 0.93, 0.94 or 0.95), 0<y<0.2 (for example, 0.02, 0.04, 0.06, 0.08, 0.1, 0.11, 0.13, 0.15, 0.17, 0.19 or 0.2), 0<z<0.2 (e.g. 0.02, 0.04, 0.06, 0.08, 0.1, 0.11, 0.13, 0.15, 0.17, 0.19 or 0.2), 0≤k≤0.05 (for example, 0, 0.01, 0.02, 0.03, 0.04 or 0.05), and M comprises at least one of Al, Mg, Zr, B, Y, Sr, W, La, Ti, and Nb.

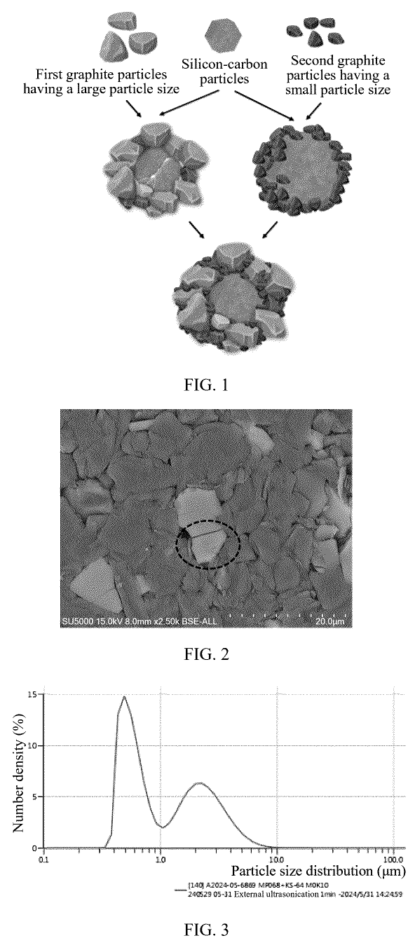

FIG. 1 shows the comparison diagram of the combined structures of the negative electrode active material particles of the present disclosure and the conventional negative electrode active material particles. As can be seen from the figure, when the negative electrode active material in the negative electrode active material layer consists of only first graphite particles having a large particle size and silicon-carbon particles, there will be obvious gaps in the contact between the particles. Since the silicon-carbon particles have a smaller powder compacted density than that of graphite and have a poor elastic deformation capability, so the surface of the silicon-carbon particles will be broken and cracked due to uneven force when the electrode plate is rolled (as shown in FIG. 2), and the degree of breakage will increase significantly with the increase of compaction.

When the negative electrode active material in the negative electrode active material layer consists of only second graphite particles having a small particle size and silicon-carbon particles, although the contact between the graphite particles and the silicon-carbon particles is closer, the gap between the electrode plates will become smaller, resulting in a decrease in the amount of residual electrolyte in the negative electrode plate and a deterioration in the ion transport performance between the electrode plates. In addition, the graphite particles having a small particle size have the disadvantages of low powder compacted density and low capacity per gram at the same time, and thus can not improve the energy density of the battery.

On the basis of the above-described problems, the composition of the negative electrode active material in the negative electrode active material layer of the present disclosure is distinguished from the above-described two cases. As shown in FIG. 1, by using a combination of first graphite particles having a large particle size, second graphite particles having a small particle size and silicon-carbon particles, the second graphite particles having a small particle size can not only effectively fill the gaps between the first graphite particles having a large particle size and the silicon-carbon particles, but also enhance the adhesion and electron transport performance between the particles, and can also avoid the significant decrease in the compacted density and capacity per gram of the electrode plate, thereby effectively improving the energy density of the battery. Furthermore, the close contact between the particles can effectively alleviate the volume expansion growth of the battery during cycling, thereby reducing the risk of deformation of the battery appearance. Moreover, the close contact between the graphite particles and the silicon-carbon particles can reduce the contact area of between the silicon-carbon particles and the electrolyte, resulting in less SEI film formed on their surface. Furthermore, the closer structure can also inhibit the continuous thickening of the SEI film on the surface of the silicon-carbon particles during long cycling, thereby effectively improving the cycling performance of the battery.

Furthermore, the positive electrode active material of the present disclosure has chemical formula of LiₐNiₓCo_{y}Mn_{z}MₖO₂, where 0.8≤a≤1.2, 0.8≤x≤0.95, 0<y<0.2, 0<z<0.2, 0≤k≤0.05, and M includes at least one of Al, Mg, Zr, B, Y, Sr, W, La, Ti and Nb, and the positive electrode active material has a higher nickel content, and the ternary material with high nickel content (0.8≤x) has a higher reversible specific capacity than the positive electrode active material with low nickel content. As the main redox reaction element in the ternary material, the higher the nickel content, the more obvious the improvement of the specific capacity of the material. More importantly, the high nickel content is beneficial to increase the deposition amount of transition metal element (Ni) in the negative electrode active material layer, thereby effectively improving the flexibility and stability of the SEI film formed on the surface of the silicon-carbon particles, inhibiting the expansion of the negative electrode active material and extending the cycle life of the electrode plate.

The battery of the present disclosure can effectively improve the cycling kinetic performance of batteries of high-nickel ternary silicon carbon system, alleviate the cycling expansion growth, and avoid the appearance deformation problems such as body thickening, edge wrinkling and corner cracking of pouch batteries due to excessive expansion, thereby effectively extending the cycle life of the battery.

In the present disclosure, the particle sizes Dv50 of the first graphite particles, the second graphite particles and the silicon-carbon particles may be the sizes measured by two different ways: the size of the as-selected material and the size observed after the negative electrode plate is made; wherein the as-selected material size is specifically measured by using a laser particle size analyzer, and the measurement method is as follows: measurement is performed using a Malvern particle size tester, and the steps of the measurement are as follows: dispersing the material in deionized water containing a dispersant (e.g., nonylphenol polyoxyethylene ether, with a content of 0.02-0.03 wt %) to form a mixture, subjecting the mixture to ultrasonic treatment for 2 min, and then placing same into the Malvern particle size tester for measurement, so as to obtain the particle size distribution data of the material; the size observed after the negative electrode plate is made is specifically obtained by performing observation and measurement using an electron microscope followed by averaging, and the measurement method is as follows: measurement is performed using a Hitachi thermal field emission scanning electron microscope (SU5000) and an image processing software, and the steps of the measurement are as follows: cutting the negative electrode plate to an appropriate size, and then fixing same on the sample stage, performing gold spraying treatment, and then obtaining an electron microscope image with a magnification of 1000× through the backscattering mode of a scanning electron microscope, and then statistically analyzing the sizes of different particles in the electron microscope image through image processing software, so as to obtain the average size of the particles; the particle sizes Dv50 measured by the above two different ways are both included in the particle size ranges of the first graphite particles, the second graphite particles and the silicon-carbon particles.

In the present disclosure, the content in percentage (%) of Si element in the negative electrode active material layer is C_{Si}, the negative electrode active material coating comprises at least one of elements Ni, Co and Mn, and in the negative electrode active material layer, the content of the element Ni is C_{Ni}, the content of the element Co is C_{Co}, and the content of the element Mn is C_{Mn} (in ppm); and C_{Si}, C_{Ni}, C_{Co} and C_{Mn} satisfy: 10≤C_{Ni}/[C_{Si}×(C_{Co}+C_{Mn})]≤20. It should be noted that the contents of elements Ni, Co and Mn in the negative electrode active material layer are all the contents in the negative electrode active material coating as measured after the battery is cycled for 300 T; and the specific measurement method can be conventional methods in the art, such as inductively coupled plasma optical emission spectrometer (ICP-OES).

In an embodiment, 10.8≤C_{Ni}/[C_{Si}×(C_{Co}+C_{Mn})]≤18.6.

In another embodiment, 13≤C_{Ni}/[C_{Si}×(C_{Co}+C_{Mn})]≤16.

The transition metal nickel element facilitates the formation of a more stable and flexible SEI film on the silicon-carbon particles, which effectively improves the cycle life of the battery. However, the transition metal cobalt element and the transition metal manganese element will destroy the structure of the SEI film, aggravate the side reaction between the silicon-carbon particles and the electrolyte, and greatly increase the risks of battery gas evolution and capacity diving. Therefore, the contents of transition metal elements deposited in the negative electrode active material layer should be matched with a suitable positive electrode active material of lithium nickel cobalt manganese oxide on the basis of the content in percentage of Si element in the negative electrode active material layer. When C_{Ni}/[C_{Si}×(C_{Co}+C_{Mn})]<10.8, it indicates that the content of nickel element in the ternary positive electrode active material (NCM) is low, which in turn leads to an insufficient content of transition metal nickel element in the negative electrode active material layer, and accordingly, the silicon-carbon particles fail to form a stable SEI film, with the increase of the number of cycles, serious lithium precipitation will occur locally on the negative electrode plate. When C_{Ni}/[C_{Si}×(C_{Co}+C_{Mn})]>18.6, it indicates that the content of nickel element in the ternary positive electrode active material (NCM) is too high, such that the cycling performance of the material will deteriorate sharply, the thermal stability will degrade, and the battery is highly prone to gas evolution.

In the present disclosure, C_{Si} can be 4%-36%, for example, 4%, 5%, 6%, 7%, 8%, 9%, 10%, 12%, 14%, 16%, 18%, 20%, 21%, 23%, 25%, 27%, 29%, 30%, 32%, 34% or 36%. In an embodiment, C_{Si} is 5%-15%.

The measurement method for the content in percentage (%) of element Si in the negative electrode active material layer is as follows: disassembling the battery, taking out the negative electrode plate, soaking and rinsing same with DMC and then drying, removing the copper foil to obtain the powder of the negative electrode active material layer; placing the powder of the negative electrode active material layer in an argon atmosphere, and heating same to 250° C. at 10° C./min, the weight of the powder of the negative electrode active material layer at this time is recorded as the initial weight W1, then switching to an air atmosphere, heating the powder to 900° C. at 10° C./min and maintaining the temperature for 8 h, the weight of the powder of the negative active material layer at this time is recorded as the final weight W2; and the mass content of element Si in the negative electrode active material layer is W2/W1/(60/28). When W2/W1 is less than 4%, the incorporation amount of the silicon-carbon particles is small, the capacity per gram of the negative electrode plate is too low, and the energy density of the battery can not meet the demand. When W2/W1 is greater than 36%, the incorporation amount of the silicon-carbon particles is large, the expansion rate of the negative electrode plate is large, and the coating in the electrode plate will be pulverized and demoulded during cycling, leading to the deformation of the battery appearance and high safety risk. Therefore, it is necessary to adjust the mass content of element Si in the negative electrode active material layer to a suitable range, so as to meet the requirement of high energy density while better controlling the expansion risk caused by the use of the silicon-carbon particles.

In the present disclosure, C_{Ni} is 50 ppm-150 ppm, for example, 50 ppm, 60 ppm, 70 ppm, 80 ppm, 90 ppm, 100 ppm, 110 ppm, 120 ppm, 130 ppm, 140 ppm or 150 ppm. In an embodiment, C_{Ni} is 90 ppm-120 ppm.

In the present disclosure, C_{Co} is 30 ppm-100 ppm, for example, 30 ppm, 40 ppm, 50 ppm, 60 ppm, 70 ppm, 80 ppm, 90 ppm or 100 ppm. In an embodiment, C_{Co} is 50 ppm-70 ppm.

In the present disclosure, C_{Mn} is 2 ppm-15 ppm, for example, 2 ppm, 3 ppm, 4 ppm, 5 ppm, 6 ppm, 7 ppm, 8 ppm, 9 ppm, 10 ppm, 11 ppm, 12 ppm, 13 ppm, 14 ppm or 15 ppm. In an embodiment, C_{Mn} is 4 ppm-8 ppm.

In the present disclosure, the number particle size distribution curve of the second graphite particles have two characteristic peaks in the range of 0 μm-10 μm, where the first characteristic peak is located at 0.5 μm-2 μm, for example, 0.5 μm, 0.6 μm, 0.7 μm, 0.8 μm, 0.9 μm, 1μ, 1.1μ, 1.2 μm, 1.3 μm, 1.4 μm, 1.5 μm, 1.6 μm, 1.7 μm, 1.8 μm, 1.9 μm or 2 μm; and the second characteristic peak is located at 3 μm-6 μm, for example, 3 μm, 4 μm, 5 μm or 6 μm. FIG. 2 shows a graph of number particle size distribution curve of the second graphite particles in an example of the present disclosure.

In the present disclosure, the particle size of the graphite particles is controlled by adjusting the aggregate particle size and the synthesis processes such as shaping, granulation and sieving, and the particle size of the silicon-carbon particles is controlled by selecting a carbon matrix having an appropriate size and the sieving process.

In the present disclosure, the particle size Dv50 of the first graphite particles can be 5 μm-15 μm, for example, 5 μm, 6 μm, 7 μm, 8 μm, 9 μm, 10 μm, 11 μm, 12 μm, 13 μm, 14 μm or 15 μm.

In an embodiment, the particle size Dv50 of the first graphite particles is 8 μm-12 μm.

In the present disclosure, the particle size Dv50 of the second graphite particles can be 2 μm-8 μm, for example, 2μ, 3 μm, 4μ, 5μ, 6 μm, 7 μm or 8μ m.

In an embodiment, the particle size Dv50 of the second graphite particles is 3 μm-6 μm. In another embodiment, the particle size Dv50 of the second graphite particles is 4 μm-5 μm.

In the present disclosure, the particle size Dv50 of the silicon-carbon particles can be 6 μm-13 μm, for example, 6 μm, 7 μm, 8 μm, 9 μm, 10 μm, 11 μm, 12 μm or 13 μm.

In an embodiment, the particle size Dv50 of the silicon-carbon particles is 8 μm-11 μm.

In the present disclosure, the particle size Dn50 of the first graphite particles can be 3 μm-12 μm, for example, 3 μm, 4 μm, 5 μm, 6 μm, 7 μm, 8 μm, 9 μm, 10 μm, 11 μm or 12 μm.

In an embodiment, the particle size Dn50 of the first graphite particles is 5 μm-10 μm.

In the present disclosure, the particle size Dn50 of the second graphite particles can be 0.5 μm-2 μm, for example, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm or 2 μm.

In an embodiment, the particle size Dn50 of the second graphite particles is 0.6 μm-0.9 μm.

In the present disclosure, the particle size Dn50 of the silicon-carbon particles can be 4 μm-10 μm, for example, 4 μm, 4.5 μm, 5 μm, 5.5 μm, 6 μm, 6.5 μm, 7 μm, 7.5 μm, 8 μm, 8.5 μm, 9 μm, 9.5 μm or 10 μm.

In an embodiment, the particle size Dn50 of the silicon-carbon particles is 5 μm-8 μm.

When the particle sizes Dv50 and Dn50 of the first graphite particles are too large, the capacity of the battery may be reduced, and the first graphite particles having too large particle size may fail to achieve complete filling, resulting in a decrease in the utilization rate of the active material, which is not conducive to improving the fast charging performance of the negative electrode. When the particle sizes Dv50 and Dn50 of the first graphite particles are too small, a large volume expansion or contraction may occur during the charging and discharging process, resulting in cracking or detachment of the active material, which is not conducive to improving the compacted density of the negative electrode.

When the particle sizes Dv50 and Dn50 of the silicon-carbon particles are too large, the silicon-carbon particles are more prone to break during a rolling process of the electrode plate, which will increase the expansion of the negative electrode plate and affect the cycling performance. When the particle sizes Dv50 and Dn50 of the silicon-carbon particles are too small, the specific surface area of the silicon-carbon particles will increase, and more SEI films will be generated, which aggravates the side reactions on the surface of the particles, thereby accelerating the failure of the battery cycling.

If the Dv50 and Dn50 of the second graphite particles are too large or too small, it is not conducive to filling the gaps between the first graphite particles and the silicon-carbon particles. However, the second graphite particles of the present disclosure have the characteristics of bimodal distribution; as shown in FIG. 2, the small-particle-size graphite particles with a number particle size ranging from 3 μm to 6 μm at the second characteristic peak can fill the gaps between the first graphite particles having a large particle size and the silicon-carbon particles, which not only enhances the adhesion between the particles, but also increases the stressed area of the silicon-carbon particles, thereby avoiding the breakage after rolling; furthermore, the ultra-small-particle-size graphite particles with a number particle size ranging from 0.5 μm to 1 μm at the first characteristic peak further fill the tiny gaps between the small-particle-size graphite particles with a number particle size ranging from 3 μm to 6 μm at the second characteristic peak, which further enhances the adhesion between the particles, thereby greatly improving the peel force and kinetic performance of the electrode plate.

In summary, the present disclosure can optimize the comprehensive performance of the negative electrode plate and the secondary battery formed therewith by rationally matching the particle sizes of the graphite particles having a large particle size, graphite particles having a small particle size and silicon-carbon particles.

In the present disclosure, the particle size Dn50 of the first graphite particles is D1, the particle size Dn50 of the second graphite particles is D2, and the particle size Dn50 of the graphite particles is D3; and D1, D2 and D3 satisfy: 0.3≤D3/(D1+D2)≤0.5, which may be, for example, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49 or 0.5.

In an embodiment, 0.35≤D3/(D1+D2)≤0.45.

When D3/(D1+D2) is less than 0.3, it indicates that the quantity proportion of the second graphite particles having a small particle size in the graphite particles is too large, resulting in excessively small capacity per gram and compacted density of the mixed graphite particles, which is not conducive to improving the energy density of the secondary battery. Moreover, an excessive amount of the second graphite particles having a small particle size may greatly increase the area where SEI film is formed, which accelerates the consumption of the electrolyte and affects the cycling performance of the secondary battery. When D3/(D1+D2) is greater than 0.5, it indicates that the quantity proportion of the second graphite particles having a small particle size in the mixed graphite particles is too small, and the amount is not sufficient for filling the gap between the first graphite particles and the silicon-carbon particles, resulting in an excessively small contact area between the silicon-carbon particles and the graphite particles in the electrode plate, so that during the rolling process of the negative electrode plate, the surface stress of the silicon-carbon particles is more concentrated, and when subjected to greater pressure, they will break to varying degrees, resulting in poor battery performance.

In the present disclosure, the particle size Dv50 of the graphite particles is D4, and the particle size Dv50 of the silicon-carbon particles is D5; and D4 and D5 satisfy: 0.88≤D4/D5≤1.12, which may be, for example, 0.88, 0.9, 0.92, 0.94, 0.96, 0.98, 1, 1.02, 1.04, 1.06, 1.08, 1.1 or 1.12.

In an embodiment, 0.94≤D4/D5≤1.06.

When D4/D5 is less than 0.88, it indicates that the particle size of the graphite particles is too small relative to the particle size of the silicon-carbon particles, resulting in a low capacity per gram of the graphite particles and a low powder compacted density, which is not conducive to improving the energy density of the battery while also aggravating the breakage of the silicon-carbon particles. When D4/D5 is greater than 1.12, it indicates that the particle size of the silicon-carbon particles is too small relative to the particle size of graphite, and the specific surface area of the silicon-carbon particles is too large, which will result in the formation of more thicker SEI films on the surface and greatly increase the expansion thickness of the electrode plate and easily accelerate the consumption of the electrolyte.

Therefore, by adjusting the above-mentioned relationship to a suitable range, the present disclosure can ensure that, in a case of a higher incorporation amount of the silicon-carbon particles, the expansion rate of the negative electrode plate in 50% SOC is reduced as much as possible, and the cycling expansion growth rate is slower, thereby greatly extending the cycle life of the battery.

In the present disclosure, the mass content of the silicon-carbon particles in the negative electrode active material can be 10%-60%, for example, 10%, 15%, 20%, 25%, 30%, 35%, 40%, 45%, 50%, 55%, or 60%.

In an embodiment, the mass content of the silicon-carbon particles in the negative electrode active material is 20%-40%.

In the present disclosure, the mass content of the first graphite particles in the negative electrode active material can be 24%-82%, for example, 24%, 26%, 28%, 30%, 32%, 34%, 36%, 38%, 40%, 42%, 44%, 46%, 48%, 50%, 52%, 54%, 56%, 58%, 60%, 65%, 70%, 75%, 80% or 82%.

In an embodiment, the mass content of the first graphite particles in the negative electrode active material is 65%-75%.

In the present disclosure, the mass content of the second graphite particles in the negative electrode active material can be 4%-36%, for example, 4%, 6%, 8%, 10%, 12%, 14%, 16%, 18%, 20%, 22%, 24%, 26%, 28%, 30%, 32%, 34% or 36%.

In an embodiment, the mass content of the second graphite particles in the negative electrode active material is 8%-16%.

In the present disclosure, the content of element Si in the silicon-carbon particles can be 40-60%, for example, 40%, 45%, 50%, 55% or 60%.

In an embodiment, the content of element Si in the silicon-carbon particles is 45%-55%.

In the present disclosure, the particle size Dn50 of the graphite particles is 0.5 μm-15 μm, and the particle size Dv50 of the graphite particles is 3 μm-18 μm; preferably the particle size Dn50 of the graphite particles is 2 μm-10 μm, and the particle size Dv50 of the graphite particles is 6 μm-12 μm.

In the present disclosure, the silicon-carbon particles have a core-shell structure, the core of the core-shell structure comprises porous carbon and silicon located in the pores of the porous carbon, and the shell of the core-shell structure comprises a carbon material.

In the present disclosure, the average sphericity of the silicon-carbon particles can be 0.5-0.9, for example, 0.5, 0.6, 0.7, 0.8 or 0.9. A test method therefor comprises: analyzing the image of each particles in the SEM image of the composite material at a given magnification (e.g., ×2.5 K) by means of an image processing software (e.g., Image Pro Plus), so as to obtain the perimeter and area of each particle; separately calculating the perimeter-equivalent radius r1 and the area-equivalent radius r2 of each particle, and then the sphericity S of each particle is r2/r1; and then calculating the number-weighted average of the sphericity of all the particles so as to obtain the average sphericity of the composite-material silicon-carbon particles. When the average sphericity is less than 0.5, it indicates that the morphology of the silicon-carbon particles is irregular, so that during a rolling process of the electrode plate, the silicon-carbon particles are prone to be broken in different degrees because of uneven stress, which not only leads to a decrease in the initial efficiency of full cells, but also greatly increases the expansion of the electrode plate. When the average sphericity is greater than 0.9, it indicates that the morphology of the silicon-carbon particles is close to spherical, although the compression resistance of the silicon-carbon particles is greatly improved, the adhesion performance thereof is deteriorated. Since the volume of the silicon-carbon particles changes significantly during charging and discharging, and the adhesion is not enough, poor contact between the particles will easily occurs in late cycling stage, which will affect the intercalation and deintercalation of lithium ions, resulting in occurrence of black spots and lithium precipitation in the negative electrode plate.

In the present disclosure, the powder compacted density of the graphite particles at a pressure of 5 tons can be 1.6 g/cm³-2 g/cm³, for example, 1.6 g/cm³, 1.61 g/cm³, 1.62 g/cm³, 1.63 g/cm³, 1.64 g/cm³, 1.65 g/cm³, 1.66 g/cm³, 1.67 g/cm³, 1.68 g/cm³, 1.69 g/cm³, 1.7 g/cm³, 1.71 g/cm³, 1.72 g/cm³, 1.73 g/cm³, 1.74 g/cm³, 1.75 g/cm³, 1.76 g/cm³, 1.78 g/cm³, 1.79 g/cm³, 1.8 g/cm³, 1.82 g/cm³, 1.84 g/cm³, 1.86 g/cm³, 1.88 g/cm³, 1.9 g/cm³, 1.91 g/cm³, 1.93 g/cm³, 1.95 g/cm³, 1.97 g/cm³, 1.99 g/cm³ or 2 g/cm³. When the powder compacted density at a pressure of 5 tons is less than 1.6 g/cm³, the compacted density of the negative electrode plate is low, which is not conducive to improving the energy density of the battery, and the silicon-carbon particles are prone to breakage under large pressures. When the powder compacted density at a pressure of 5 tons is greater than 2 g/cm³, the particle size of the graphite particles is too large, which is not conducive to improving the fast-charging performance of the battery. A test method therefor comprises: uniformly mixing the first graphite particles having a large particle size and the second graphite particles having a small particle size in proportion, then weighing 1±0.001 g of the mixed powder and transferring same into a test mold, and subjecting same to a “5 T powder compacted density rapid test” procedure on an automatic powder compaction press to obtain the MD-5T of the mixed powder.

In an embodiment, the powder compacted density of the graphite particles at a pressure of 5 tons is 1.65 g/cm³-1.75 g/cm³.

In the present disclosure, the porosity of the negative electrode active material layer is 30-50%, for example, 30%, 35%, 40%, 45%, or 50%. When the porosity of the negative electrode active material layer is less than 30%, the space within the interior of the coating is insufficient to accommodate the electrolyte, which is not conducive to the ion transport between the active materials. There is a risk of overvoltage on the electrode plate, resulting in the breakage of the silicon-carbon particles. When the porosity of the negative electrode active material layer is greater than 50%, the contact between the particles is not close enough, which is not conducive to electron transport. In addition, the excessive amount of residual electrolyte inside aggravates the side reaction between the silicon-carbon particles and the electrolyte, so that the SEI film is thickened, and the expansion growth of the electrode plate is accelerated. A test method therefor comprises: disassembling the lithium-ion secondary battery after being discharged to 0% SOC, and taking out the negative electrode plate, then soaking the electrode plate in a dimethyl carbonate (DMC) solvent for 12 h and then rinsing same with DMC to remove a lithium salt attached thereto, after drying in the air, cutting the negative electrode plate into discs having a diameter of 12 mm with a slicer, measuring the thickness of the 20 discs with a micrometer, separately calculating the volume of each disc and summing to obtain the sum of the volumes of the 20 discs which is recorded as V1; and then measuring the true volume of the 20 discs by a true density analyzer (e.g., a JW-M100A fully automated true density analyzer from JWGB Instrument) which is recorded as V2, with helium as a measuring gas and an ambient temperature during measurement being 25±2° C. Then the porosity of the negative electrode active material layer of the negative electrode plate is (V1−V2)/V1*100%.

In an embodiment, the porosity of the negative electrode active material layer is 35%-45%.

In the present disclosure, the peel strength between the negative electrode active material layer and the negative electrode current collector can be 0.5 gf/mm-2 gf/mm, for example, 0.5 gf/mm, 0.6 gf/mm, 0.7 gf/mm, 0.8 gf/mm, 0.9 gf/mm, 1 gf/mm, 1.1 gf/mm, 1.2 gf/mm, 1.3 gf/mm, 1.4 gf/mm, 1.5 gf/mm, 1.6 gf/mm, 1.7 gf/mm, 1.8 gf/mm, 1.9 gf/mm or 2 gf/mm. When the peel strength between the negative electrode active material layer and the negative electrode current collector is less than 0.5 gf/mm, the adhesion between the coating and the electrode plate is insufficient, and during repeated charging and discharging process, the coating is prone to detachment and displacement, causing short circuit inside the battery. When the peel strength between the negative electrode active material layer and the negative electrode current collector is greater than 2 gf/mm, the electrode plate suffers overvoltage, so that the active particle material is prone to breakage, which is not conductive to the performance of the battery. A test method therefor comprises: disassembling the lithium-ion secondary battery after being discharged to 0% SOC, and taking out the negative electrode plate, then soaking the electrode plate in a dimethyl carbonate (DMC) solvent for 12 h and then rinsing same with DMC to remove a lithium salt attached thereto, after drying in the air, cutting the negative electrode plate into a square sheet with a length of 400 mm and a width of 50 mm using a slicer, fixing the square sheet onto a thin steel plate using a double-sided adhesive, then performing test using a universal tensile testing machine to obtain the peel strength curve, average value and standard curve.

In an embodiment, the peel strength between the negative electrode active material layer and the negative electrode current collector is 1 gf/mm-1.5 gf/mm.

In the present disclosure, the OI value of the negative electrode active material layer can be 10-25, for example, 10, 11, 12, 13, 14, 15, 16, 17, 18, 19, 20, 21, 22, 23, 24 or 25. When the OI value of the negative electrode active material layer is less than 10, the initial expansion of the negative electrode active material layer in the thickness direction is too small, and the space in which the negative electrode active material layer can accommodate the electrolyte is small. When the OI value of the negative electrode active material layer is greater than 25, the cycling expansion of the negative electrode active material layer in the thickness direction is too large, the contact between the particles is not close enough, which may deteriorate the kinetics of the electrode plate. A test method therefor comprises: disassembling the lithium-ion secondary battery after being discharged to 0% SOC, and taking out the negative electrode plate, then soaking the electrode plate in a dimethyl carbonate (DMC) solvent for 12 h and then rinsing same with DMC to remove a lithium salt attached thereto, after drying in the air, performing test with an X-ray powder diffraction instrument (e.g., an XRD-6100 X-ray diffractometer from Shimadzu). In the obtained diffraction pattern, the diffraction peak appearing at 2θ of 54-55° is the (004) peak of graphite, with the intensity thereof being denoted as I₀₀₄, the diffraction peak appearing at 2θ of 77-78° is the (110) peak of graphite, with the intensity thereof being denoted as I₁₁₀, and then the OI value of the negative electrode plate is 1004/1110.

In an embodiment, the OI value of the negative electrode active material layer is 12-18.

In the present disclosure, at least part of the second graphite particles are located in gaps between the first graphite particles and the silicon-carbon particles.

In the present disclosure, the positive electrode plate comprises a positive electrode current collector and a positive electrode active material layer located on a surface on at least one side of the positive electrode current collector; the capacity per unit area of the positive electrode active material layer is Q1, the capacity per unit area of the negative electrode active material layer is Q2, and Q1 and Q2 satisfy: 1<Q2/Q1≤1.15, for example, 1.01, 1.02, 1.03, 1.04, 1.05, 1.06, 1.07, 1.08, 1.09, 1.1, 1.11, 1.12, 1.13, 1.14 or 1.15. When Q2/Q1≤1, the capacity of the negative electrode plate is too low relative to that of the positive electrode plate, there is a risk of lithium precipitation on the negative electrode plate. When Q2/Q1>1.15, the capacity of the positive electrode plate is too low relative to that of the negative electrode plate, which is not conductive to improving the energy density of the battery. The measurement method for the capacity per unit area of the negative electrode active material layer Q2 comprises: performing lithium intercalation on the negative electrode plate at a current of 0.05 C, when the potential reaches 5 mV (vs. Li/Li+), leaving the electrode plate to stand for 10 min; performing lithium intercalation again on the negative electrode plate at a current of 0.02 C, when the potential reaches 5 mV, leaving the electrode plate to stand for 10 min; and performing delithiation on the negative electrode plate at a current of 0.05 C until the potential reaches 0.9 V (vs. Li/Li+); and cycling the above procedure 3 times. Then the third delithiation capacity divided by the surface area of the negative electrode plate is calculated as Q2. The measurement method for the capacity per unit area of the positive electrode active material layer Q1 comprises: performing delithiation on the positive electrode plate at a current of 0.05 C, when the potential reaches 4.35 V (vs. Li/Li+), leaving the electrode plate to stand for 10 min; performing delithiation again on the positive electrode plate at a current of 0.02 C, when the potential reaches 4.35 V, leaving the electrode plate to stand for 10 min; and performing lithium intercalation on the positive electrode plate at a current of 0.05 C until the potential reaches 3.3 V (vs. Li/Li+); and cycling the above procedure 3 times. Then the third lithium intercalation capacity divided by the surface area of the positive electrode plate is calculated as Q1.

In an embodiment, 1.05≤Q2/Q1≤1.1.

In the present disclosure, Q1 is 1 mAh/cm²-5 mAh/cm², for example, 1 mAh/cm², 2 mAh/cm², 2.1 mAh/cm², 2.2 mAh/cm², 2.3 mAh/cm², 2.4 mAh/cm², 2.5 mAh/cm², 2.6 mAh/cm², 2.7 mAh/cm², 2.8 mAh/cm², 2.9 mAh/cm², 3 mAh/cm², 3.1 mAh/cm², 3.2 mAh/cm², 3.3 mAh/cm², 3.4 mAh/cm², 3.5 mAh/cm², 3.6 mAh/cm², 3.7 mAh/cm², 3.8 mAh/cm², 3.9 mAh/cm², 4 mAh/cm² or 5 mAh/cm². In an embodiment, Q1 is 2 mAh/cm²-4 mAh/cm².

In the present disclosure, Q2 is 1 mAh/cm²-5.8 mAh/cm², for example, 1, 2.1 mAh/cm², 2.2 mAh/cm², 2.3 mAh/cm², 2.4 mAh/cm², 2.5 mAh/cm², 2.6 mAh/cm², 2.7 mAh/cm², 2.8 mAh/cm², 2.9 mAh/cm², 3 mAh/cm², 3.1 mAh/cm², 3.2 mAh/cm², 3.3 mAh/cm², 3.4 mAh/cm², 3.5 mAh/cm², 3.6 mAh/cm², 3.7 mAh/cm², 3.8 mAh/cm², 3.9 mAh/cm², 4 mAh/cm², 4.1 mAh/cm², 4.2 mAh/cm², 4.3 mAh/cm², 4.4 mAh/cm², 4.6 mAh/cm², 4.8 mAh/cm², 5 mAh/cm², 5.6 mAh/cm² or 5.8 mAh/cm². In an embodiment, Q2 is 2.1 mAh/cm²-4.4 mAh/cm².

In the present disclosure, the particle size Dv50 of the positive electrode active material can be 1 μm-10 μm, for example, 1 μm, 2 μm, 3 μm, 4 μm, 5 μm, 6 μm, 7 μm, 8 μm, 9 μm or 10 μm. A test method therefor comprises: disassembling the lithium-ion secondary battery after being discharged to 0% SOC, and taking out the positive electrode plate, then soaking the electrode plate in a dimethyl carbonate (DMC) solvent for 12 h and then rinsing same with DMC to remove a lithium salt attached thereto, removing the aluminum foil, baking the active material at 100° C. for 30 min to obtain the powder of the positive electrode coating; and performing measurement using a laser particle size measurement method. For example, a Malvern particle size tester is used for the measurement, and the steps of the measurement are as follows: dispersing the powder in deionized water containing a dispersant (e.g., nonylphenol polyoxyethylene ether, with a content of 0.02-0.03 wt %) to form a mixture, subjecting same to ultrasonic treatment for 2 min, and then placing same into the Malvern particle size tester for measurement, so as to obtain the corresponding particle size distribution data.

In an embodiment, the particle size Dv50 of the positive electrode active material is 3 μm-5 μm.

In an embodiment, the positive electrode active material comprises single-crystal particles.

In the present disclosure, the battery further comprises an electrolyte containing 2,2-difluoroethyl acetate, the mass content of the 2,2-difluoroethyl acetate in the electrolyte is C₁, the content of the element Si in the negative electrode active material layer is C_{Si}, and C₁ and C_{Si} satisfy: 0.3≤C₁/C_{Si}≤3.5, for example, 0.3, 0.4, 0.5, 0.6, 0.7, 0.8, 0.9, 1, 1.3, 1.5, 1.7, 1.9, 2, 2.2, 2.4, 2.6, 2.8, 3, 3.1, 3.2, 3.3, 3.4 or 3.5. The mass content of 2,2-difluoroethyl acetate (DFEA) in the electrolyte is C₁, which satisfies 0.3≤C₁/C_{Si}≤3.5. DFEA facilitates the formation of a stable interfacial film on the surface of the silicon-carbon particles, which inhibits the continuous occurrence of side reactions, so that the negative electrode plate has less expansion, thereby mitigating the risk of the deformation of the battery structure. However, DFEA exhibits poor high-temperature performance in batteries, which tends to induce gas evolution issue, potentially causing safety hazards. When C₁/C_{Si}<0.3, the content of DFEA is too low, and the interfacial film on the surface of the silicon-carbon particles has low compactness and poor stability, and black spots and lithium precipitation are likely to appear on the electrode plate, accelerating the failure of the battery cycling. When C₁/C_{Si}>3.5, the content of DFEA is too high, the battery is prone to gas evolution at a high temperature, and the battery has poor kinetic performance.

In an embodiment, 1.5≤C₁/C_{Si}≤2.5.

The present disclosure will be described in detail below by means of examples. The examples described in the present disclosure are only some, rather than all, of the examples of the present disclosure. Based on the examples in the present disclosure, all other examples obtained by those of ordinary skill in the art without involving creative effort belong to the scope of protection of the present disclosure.

In the following examples, unless otherwise specified, all the materials used are commercially available and analytically pure.

The following examples are intended to illustrate the present disclosure.

### Example 1

The preparation method was as follows:

### Preparation of Negative Electrode Plate:

the first graphite particles, the second graphite particles, and the silicon-carbon particles were mechanically mixed in a mass ratio of 72:8:20 for 5 min, and the uniformly mixed mixture was used as the negative electrode active material, wherein the first graphite particles had Dv50=9.478 μm and Dn50=5.408 μm, the second graphite particles had Dv50=4.271 μm and Dn50=0.795 μm (specifically, as shown in FIG. 3, which is a graph of number particle size distribution curve of the second graphite particles in Example 1, which has two characteristic peaks in the range of 0 μm-10 μm, wherein the first characteristic peak is at 0.523 μm and the second characteristic peak is at 2.388 μm), the silicon-carbon particles had Dv50=8.591 μm and Dn50=5.884 μm; the silicon-carbon particles had a silicon-carbon mass ratio (Si:C) of 49:51, the content of element Si in the silicon-carbon particles was 49.52%, and the average sphericity of the silicon-carbon particles was 0.673.

The above-mentioned negative electrode active material, sodium carboxymethyl cellulose, styrene-butadiene rubber, Super P, and single-walled carbon nanotubes were mixed in a mass ratio of 95:2:2:0.75:0.25, an appropriate amount of water was added as a solvent, the resultant mixture was stirred until uniform using a vacuum mixer, and then the slurry was uniformly applied on the surface of a high-strength carbon-coated copper foil having a thickness of 6 μm, with the single-sided areal density of the coating being 5 mg/cm²; and the coated electrode plate was transferred to a vacuum drying oven and baked at 85° C. for 12 h. The electrode plate was rolled by using a double-roller press, the rolled electrode plate had a compacted density of 1.3 g/cm³; and the electrode plate was die-cut to give a negative electrode plate of 66 mm in length and 47 mm in width, and the negative electrode active material layer of the negative electrode plate had a capacity per unit area of 2.789 mAh/cm².

### Preparation of Positive Electrode Plate:

Lithium nickel cobalt manganese oxide (NCM955, having a chemical formula of Li_{1.01}Ni_{0.9}Co_{0.5}Mn_{0.5}M_{0.02}O₂ and a particle size Dv50=4.141 μm), polyvinylidene fluoride (PVDF), acetylene black and single-walled carbon nanotubes (CNT) were mixed in a mass ratio of 97:1.5:1.25:0.25, N-methylpyrrolidone was added as a solvent, and the mixture was stirred by using a vacuum mixer to obtain a positive electrode slurry. The positive electrode slurry was uniformly applied on a high-strength aluminum foil having a thickness of 10 μm, with the areal density of the coating being 12.3 mg/cm². The above-described aluminum foil coated with the positive electrode slurry was dried in a vacuum drying oven at 95° C. for 12 h, and the positive electrode plate was rolled by using a single-roller press, the rolled electrode plate had a compacted density of 3.3 g/cm³; and the electrode plate was die-cut to give a positive electrode plate of 63 mm in length and 45 mm in width, and the positive electrode active material layer of the positive electrode plate had a capacity per unit area of 2.621 mAh/cm².

### Laminating Process:

the die-cut positive and negative electrode plates were baked in a vacuum drying oven at 90° C. for 12 h, and a polyethylene film having a thickness of 8 μm was selected as the separator for the battery, and the above-mentioned positive electrode plate, the separator and the negative electrode plate were sequentially stacked by a lamination machine, such that the separator can separate the positive and negative electrode plates, so as to obtain a laminated cell, which had 22 positive electrode plates and 23 negative electrode plates.

### Packaging Process:

the laminated cell was fixed into a welding mold, where a positive electrode tab and a negative electrode tab were welded separately, and then fixed by using a high-temperature tape, and finally packaged with an aluminum laminate film with a thickness of 0.113 mm.

### Post-Process:

the packaged dry cell was placed in an oven at 90° C. for 48 h, after passing the moisture test, an electrolyte (C₁/C_{Si}=1.8) was injected, followed by procedures such as aging, formation, secondary packaging and sorting to obtain a lithium-ion secondary battery with an average capacity of 3200 mAh.

### Comparative Example 1

This comparative example was carried out with reference to Example 1, only except that the second graphite particles was not added into the negative electrode active material, and accordingly, the mass ratio of the first graphite particles, the second graphite particles and the silicon-carbon particles was changed to 80:00:20.

### Comparative Example 2

This comparative example was carried out with reference to Example 1, only except that the first graphite particles was not added into the negative electrode active material, and accordingly, the mass ratio of the first graphite particles, the second graphite particles and the silicon-carbon particles was changed to 00:80:20.

### Comparative Example 3

This comparative example was carried out with reference to Example 1, only except that the particle sizes of the first graphite particles and the second graphite particles added to the negative electrode active material were changed.

### Comparative Example 4

This comparative example was carried out with reference to Example 1, only except that the positive electrode active material was Li_{1.01}Ni_{0.7}Co_{0.2}Mn_{0.1}M_{0.02}O₂ and had a particle size Dv50=3.964 μm.

### Example 2 Group

This group of examples was carried out with reference to Example 1, only except that the mass contents of the first graphite particles and the second graphite particles in the negative electrode active material were changed, specifically:
in example 2-1, the mass ratio of the first graphite particles, the second graphite particles and the silicon-carbon particles was changed to 76:4:20;
in example 2-2, the mass ratio of the first graphite particles, the second graphite particles and the silicon-carbon particles was changed to 64:16:20;
in example 2-3, the mass ratio of the first graphite particles, the second graphite particles and the silicon-carbon particles was changed to 56:24:20;
in example 2-4, the mass ratio of the first graphite particles, the second graphite particles and the silicon-carbon particles was changed to 48:32:20.

### Example 3 Group

This group of examples was carried out with reference to Example 1, only except that the particle sizes of the silicon-carbon particles in the negative electrode active material were changed, specifically:
in example 3-1, the particle sizes of the silicon-carbon particles were Dv50=4.994 μm and Dn50=1.821 μm;
in example 3-2, the particle sizes of the silicon-carbon particles were Dv50=7.22 μm and Dn50=4.659 μm;
in example 3-3, the particle sizes of the silicon-carbon particles were Dv50=11.59 μm and Dn50=7.933 μm.

### Example 4 Group

This group of examples was carried out with reference to Example 1, only except that the particle sizes of the silicon-carbon particles in the negative electrode active material were changed, specifically:
in example 4-1, the particle sizes of the first graphite particles were Dv50=6.062 μm and Dn50=1.025 μm;
in example 4-2, the particle sizes of the second graphite particles were Dv50=6.062 μm and Dn50=1.025 μm;
in example 4-3, the particle sizes of the first graphite particles were Dv50=14.953 μm and Dn50=6.193 μm;
in example 4-4, the particle sizes of the second graphite particles were Dv50=15.719 μm and Dn50=8.634 μm;
in example 4-5, the particle sizes of the second graphite particles were Dv50=8.949 μm and Dn50=4.585 μm.

### Example 5-1

This example was carried out with reference to Example 1, only except that the positive electrode active material was Li_{1.01}Ni_{0.8}Co_{0.1}Mn_{0.1}M_{0.02}O₂ and had a particles size Dv50=4.458μ m.

### Example 5-2

This example was carried out with reference to Example 1, only except that the positive electrode active material was Li_{1.01}Ni_{0.92}Co_{0.04}Mn_{0.04}M_{0.02}O₂ and had a particles size Dv50=4.295 μm.

The specific particle sizes of the negative electrode active materials used for the negative electrodes of the above examples and comparative examples can be found in table 1:

TABLE 1

| | | Particle | | Particle | | | Particle | | | |
|---|---|---|---|---|---|---|---|---|---|---|
| | Particle | size | Particle | size | Particle | Particle | size | Particle | | |
| | size | Dn50 of | size | Dn50 of | size | size | Dv50 of | size | | |
| | Dv50 of | first | Dv50 of | second | Dv50 of | Dn50 of | silicon- | Dn50 of | | |
| | first | graphite | second | graphite | graphite | graphite | carbon | silicon- | D3/( | |
| | graphite | particles, | graphite | particles, | particles, | particles, | particles, | carbon | D1 + | D4/ |
| | particles/ | D1/ | particles/ | D2/ | D4/ | D3/ | D5/ | particles/ | D2) × | D5 × |
| Group | μm | μm | μm | μm | μm | μm | μm | μm | 100% | 100% |
| Example | 9.478 | 5.408 | 4.271 | 0.795 | 8.761 | 2.897 | 8.591 | 5.884 | 46.7 | 101.98 |
| 1 | | | | | | | | | | |
| Comparative | 9.478 | 5.408 | / | / | 9.478 | 5.408 | 8.591 | 5.884 | / | 110.32 |
| example | | | | | | | | | | |
| 1 | | | | | | | | | | |
| Comparative | / | / | 4.271 | 0.795 | 4.271 | 0.795 | 8.591 | 5.884 | / | 49.71 |
| example | | | | | | | | | | |
| 2 | | | | | | | | | | |
| Comparative | 5.51 | 1.016 | 5.51 | 1.016 | 5.51 | 1.016 | 8.591 | 5.884 | 50 | 64.14 |
| example | | | | | | | | | | |
| 3 | | | | | | | | | | |
| Comparative | 9.478 | 5.408 | 4.271 | 0.795 | 8.761 | 2.897 | 8.591 | 5.884 | 46.7 | 101.98 |
| example | | | | | | | | | | |
| 4 | | | | | | | | | | |
| Example | 9.478 | 5.408 | 4.271 | 0.795 | 9.159 | 3.358 | 8.591 | 5.884 | 54.14 | 106.61 |
| 2-1 | | | | | | | | | | |
| Example | 9.478 | 5.408 | 4.271 | 0.795 | 8.58 | 2.294 | 8.591 | 5.884 | 36.98 | 99.87 |
| 2-2 | | | | | | | | | | |
| Example | 9.478 | 5.408 | 4.271 | 0.795 | 7.629 | 1.965 | 8.591 | 5.884 | 31.68 | 88.8 |
| 2-3 | | | | | | | | | | |
| Example | 9.478 | 5.408 | 4.271 | 0.795 | 6.836 | 1.657 | 8.591 | 5.884 | 26.71 | 79.57 |
| 2-4 | | | | | | | | | | |
| Example | 9.478 | 5.408 | 4.271 | 0.795 | 8.761 | 2.897 | 4.994 | 1.821 | 46.7 | 175.43 |
| 3-1 | | | | | | | | | | |
| Example | 9.478 | 5.408 | 4.271 | 0.795 | 8.761 | 2.897 | 7.22 | 4.659 | 46.7 | 121.34 |
| 3-2 | | | | | | | | | | |
| Example | 9.478 | 5.408 | 4.271 | 0.795 | 8.761 | 2.897 | 11.59 | 7.933 | 46.7 | 75.59 |
| 3-3 | | | | | | | | | | |
| Example | 6.062 | 1.052 | 4.271 | 0.795 | 5.031 | 1.031 | 8.591 | 5.884 | 55.82 | 58.56 |
| 4-1 | | | | | | | | | | |
| Example | 9.478 | 5.408 | 6.062 | 1.052 | 9.025 | 4.42 | 8.591 | 5.884 | 68.42 | 105.05 |
| 4-2 | | | | | | | | | | |
| Example | 14.953 | 6.193 | 4.271 | 0.795 | 13.127 | 4.394 | 8.591 | 5.884 | 62.88 | 152.80 |
| 4-3 | | | | | | | | | | |
| Example | 15.719 | 8.634 | 4.271 | 0.795 | 14.644 | 6.937 | 8.591 | 5.884 | 73.57 | 170.46 |
| 4-4 | | | | | | | | | | |
| Example | 9.478 | 5.408 | 8.949 | 4.585 | 9.357 | 5.106 | 8.591 | 5.884 | 51.10 | 108.92 |
| 4-5 | | | | | | | | | | |
| Example | 9.478 | 5.408 | 4.271 | 0.795 | 8.761 | 2.897 | 8.591 | 5.884 | 46.7 | 101.98 |
| 5-1 | | | | | | | | | | |
| Example | 9.478 | 5.408 | 4.271 | 0.795 | 8.761 | 2.897 | 8.591 | 5.884 | 46.7 | 101.98 |
| 5-2 | | | | | | | | | | |

### Test Examples

### 1. Test for Content of Element Si in Negative Electrode Active Material Layer

The negative electrode plate was soaked and rinsed with DMC and then dried, the copper foil was removed to obtain the powder of the negative electrode active material layer; the powder of the negative electrode active material layer was placed in an argon atmosphere, and heated to 250° C. at 10° C./min, and the weight of the powder of the negative electrode active material layer at this time was recorded as the initial weight W1; then the atmosphere was switched to an air atmosphere, and the powder was heated to 900° C. at 10° C./min and the temperature was maintained for 8 h, the wight of the powder of the negative active material layer at this time was recorded as the final weight W2; and the mass content of element Si in the negative electrode active material layer was W2/W1/(60/28), and the results were reported in Table 2.

### 2. Test for Contents of Elements Ni, Co and Mn in Negative Electrode Active Material Layer

The cell to be tested was transferred to a constant temperature room at 25±1° C. and was left to stand for 30 min, the cell was charged to 4.3 V at a constant current of 1.8 C (5760 mAh), and was charged to a charge current of less than 0.05 C (160 mAh) at a constant voltage of 4.3 V and was left to stand for 10 min; then the cell was discharged to 2.5 V at a constant current of 4 C (12800 mAh) and was left to stand for 10 min, the procedure was cycled for 300 T; and the contents of elements Ni, Co and Mn were measured using an inductively coupled plasma optical emission spectrometer, and the results were reported in Table 2.

### 3. Test for Powder Compacted Density of Graphite Particles at Pressure of 5 Tons

The first graphite particles and the second graphite particles in the negative electrode active materials of the above-described examples and comparative examples were mixed uniformly in a set ratio, and then weighed 1±0.001 g of the mixed powder and transferred to a test mold, and subjected to a “5 T powder compacted density rapid test” procedure on an automatic powder compaction press to obtain the MD-5T of the mixed powder, i.e. the powder compacted density at a pressure of 5 tons, and the results were reported in Table 2.

TABLE 2

| | | | | | | Powder |
|---|---|---|---|---|---|---|
| | | | | | | compacted |
| | | | | | | density of |
| | | | | | | graphite |
| | | | | | | particles at |
| | | | | | | pressure of |
| | C_{Si}/ | C_{Ni}/ | C_{Co}// | C_{Mn}/ | C_{Ni}/[C_{Si} × | 5 tons/ |
| Group | % | ppm | ppm | ppm | (C_{Co} + C_{Mn})] | g/cm³ |
| Example 1 | 9.954 | 105.48 | 62.2 | 9.84 | 14.71 | 1.719 |
| Comparative example 1 | 9.958 | 98.38 | 67.75 | 10.27 | 12.66 | 1.757 |
| Comparative example 2 | 9.956 | 116.51 | 85.85 | 15.64 | 11.53 | 1.568 |
| Comparative example 3 | 9.947 | 110.55 | 60.92 | 13.58 | 14.92 | 1.612 |
| Comparative example 4 | 9.989 | 63.88 | 99.12 | 18.1 | 5.464 | 1.719 |
| Example 2-1 | 10.053 | 110.22 | 66.46 | 8.43 | 14.64 | 1.741 |
| Example 2-2 | 10.056 | 103.3 | 58.48 | 8.53 | 15.33 | 1.708 |
| Example 2-3 | 10.123 | 102.03 | 63.96 | 9.55 | 13.71 | 1.684 |
| Example 2-4 | 10.034 | 96.22 | 70.46 | 11.76 | 11.66 | 1.659 |
| Example 3-1 | 9.954 | 106.96 | 82.17 | 17.02 | 10.83 | 1.719 |
| Example 3-2 | 9.942 | 107.41 | 55.57 | 6.83 | 17.31 | 1.719 |
| Example 3-3 | 9.939 | 88.59 | 58.51 | 8.86 | 13.23 | 1.719 |
| Example 4-1 | 10.034 | 114.77 | 90.21 | 17.64 | 10.61 | 1.594 |
| Example 4-2 | 9.994 | 102.68 | 70.45 | 12.6 | 12.37 | 1.738 |
| Example 4-3 | 9.984 | 95.35 | 58.20 | 7.29 | 14.58 | 1.979 |
| Example 4-4 | 9.99 | 92.92 | 60.28 | 9.94 | 13.24 | 1.973 |
| Example 4-5 | 10.021 | 105.8 | 74.13 | 12.38 | 12.2 | 1.741 |
| Example 5-1 | 10.234 | 86.51 | 71.85 | 14.64 | 9.77 | 1.719 |
| Example 5-2 | 10.178 | 119.45 | 60.49 | 5.86 | 17.69 | 1.719 |

### 4. Test for Porosity of Negative Electrode Active Material Layer of Negative Electrode Plate

after being discharged to 0% SOC, the lithium-ion secondary battery was disassembled, and the negative electrode plate was taken out, then soaked in a dimethyl carbonate (DMC) solvent for 12 h and then rinsed with DMC to remove a lithium salt attached thereto, after drying in the air, the negative electrode plate was cut into discs having a diameter of 12 mm with a slicer, the thickness of 20 discs was measured with a micrometer, the volume of each disc was separately calculated and summed to obtain the sum of the volumes of the 20 discs which is recorded as V1; and then the true volume of the 20 discs was measured by a true density analyzer (e.g., a JW-M100A fully automated true density analyzer from JWGB Instrument) which is recorded as V2, with helium as a measuring gas and an ambient temperature during measurement being 25±2° C. Then the porosity of the negative electrode active material layer of the negative electrode plate was (V1−V2)/V1*100%, and the results were reported in Table 3.

### 5. Test for Peel Strength Between Negative Electrode Active Material Layer and Negative Electrode Current Collector

After being discharged to 0% SOC, the lithium-ion secondary battery was disassembled, and the negative electrode plate was taken out, then the electrode plate was soaked in a dimethyl carbonate (DMC) solvent for 12 h and then rinsed with DMC to remove a lithium salt attached thereto, after drying in the air, the negative electrode plate was cut into a square sheet with a length of 400 mm and a width of 50 mm using a slicer, the square sheet was fixed onto a thin steel plate using a double-sided adhesive, then test was performed using a universal tensile testing machine to obtain the peel strength curve between the negative electrode active material layer and the negative electrode current collector, the average value, standard curve and peel strength were obtained and reported in Table 3.

### 6. Test for OI Value of Negative Electrode Active Material Layer of Negative Electrode Plate

after being discharged to 0% SOC, the lithium-ion secondary battery was disassembled, the negative electrode plate was taken out, then soaked in a dimethyl carbonate (DMC) solvent for 12 h and then rinsed with DMC to remove a lithium salt attached thereto, after drying in the air, test was performed with an X-ray powder diffraction instrument (e.g., an XRD-6100 X-ray diffractometer from Shimadzu). In the obtained diffraction pattern, the diffraction peak appearing at 2θ of 54-55° was the (004) peak of graphite, with the intensity thereof being denoted as I₀₀₄, the diffraction peak appearing at 2θ of 77-78° was the (110) peak of graphite, with the intensity thereof being denoted as I₁₁₀, and then the OI value of the negative electrode plate was I₀₀₄/I₁₁₀; the results were reported in Table 3.

### 7. Test for Capacity Per Unit Area of Negative Electrode Active Material Layer Q2

Lithium intercalation was performed on the negative electrode plate at a current of 0.05 C, when the potential reached 5 mV (vs. Li/Li+), the electrode plate was left to stand for 10 min; lithium intercalation was performed again on the negative electrode plate at a current of 0.02 C, when the potential reached 5 mV, the electrode plate was left to stand for 10 min; and delithiation was performed on the negative electrode plate at a current of 0.05 C until the potential reached 0.9 V (vs. Li/Li+); and the above procedure was cycled for 3 times. Then the third delithiation capacity divided by the surface area of the negative electrode plate was calculated as Q2, and the results were reported in Table 3.

### 8. Test for Capacity Per Unit Area of Positive Electrode Active Material Layer Q1

Delithiation was performed on the positive electrode plate at a current of 0.05 C, when the potential reached 4.35 V (vs. Li/Li+), the electrode plate was left to stand for 10 min; delithiation was performed again on the positive electrode plate at a current of 0.02 C, when the potential reached 4.35 V, the electrode plate was left to stand for 10 min; and lithium intercalation was performed on the positive electrode plate at a current of 0.05 C until the potential reached 3.3 V (vs. Li/Li+); and the above procedure was cycled for 3 times. Then the third lithium intercalation capacity divided by the surface area of the positive electrode plate was calculated as Q1, and the results were reported in Table 3.

### 9. Test for Cycling Performance

The battery to be tested was transferred to a constant temperature room at 25±1° C. and was left to stand for 30 min, the cell was charged to 4.3 V at a constant current of 1.8 C (5760 mAh), and was charged to a charge current of less than 0.05 C (160 mAh) at a constant voltage of 4.3 V, and was left to stand for 10 min; the thickness of the cell Qx (X=number of cycles, 600 T) was measured with a thickness gauge; and the cell was discharged to 2.5 V at a constant current of 4 C (12,800 mAh), and was left to stand for 10 minutes; the above test constituted one complete cycle; the discharge capacity (mAh) was recorded as Rx (X=number of cycles), and the capacity retention rate Ux=Rx/R1*100%; furthermore, the appearance of the battery was observed at this time, and categorized as: no abnormality, body thickening, body pitting, slight gas evolution and severe gas evolution, and the results were reported in Table 4.

### 10. Test for Cycling Expansion Rate

The battery was charged to 3.8 V at a constant current of 1.8 C, and charged to a charge current of less than 0.05 C at a constant voltage of 3.8 V and was left to stand for 10 minutes, and the battery was in a 50% SOC state at this time; the weight of the battery was measured by using a mass measuring instrument and recored as W Kg, the thickness of the battery was measured by using a thickness gauge and recored as Q0 mm, and the cycling expansion rate of the battery Lx=Qx/Q0*100%, and the results were reported in Table 4.

### 11. Test for Wight Energy Density

En (discharge energy)=R1 (discharge capacity of the first cycle)*V1 (average discharge voltage of the first cycle), and then the weight energy density WED=En/W (Wh/Kg), and the results were reported in Table 4.

### 12. Test for Rebound Rate of Electrode Plate in 50% SOC State

The battery was charged to 3.8 V at a constant current of 1.8 C, and charged to a charge current of less than 0.05 C at a constant voltage of 3.8 V and was left to stand for 10 min, and the battery was in a 50% SOC state at this time; by disassembling the battery, the negative electrode plate was separated, and the thicknesses of the electrode plate at different positions were measured with a micrometer, the average value of the thicknesses was calculated and recorded as N2 mm, the thickness of the negative electrode plate after rolling was recorded as N1 mm, and then the rebound rate of the electrode plate in a 50% SOC state is N=(N2−0.006)/(N1−0.006)*100%, and the results were reported in Table 4.

TABLE 3

| | | Peel | | | | |
|---|---|---|---|---|---|---|
| | Porosity/ | strength/ | OI | Q2/ | Q1/ | |
| Group | % | gf/mm | value | mAh/cm² | mAh/cm² | Q2/Q1 |
| Example 1 | 44.24 | 1.384 | 16.34 | 2.789 | 2.621 | 1.06 |
| Comparative example 1 | 46.42 | 0.504 | 11.94 | 2.789 | 2.621 | 1.06 |
| Comparative example 2 | 41.46 | 0.585 | 16.52 | 2.738 | 2.573 | 1.06 |
| Comparative example 3 | 45.84 | 0.626 | 12.56 | 2.809 | 2.642 | 1.06 |
| Comparative example 4 | 43.87 | 1.359 | 16.27 | 2.789 | 2.621 | 1.06 |
| Example 2-1 | 45.39 | 0.789 | 12.66 | 2.789 | 2.621 | 1.06 |
| Example 2-2 | 43.56 | 1.288 | 13.79 | 2.785 | 2.617 | 1.06 |
| Example 2-3 | 42.83 | 1.258 | 14.39 | 2.78 | 2.612 | 1.06 |
| Example 2-4 | 42.05 | 0.926 | 15.13 | 2.776 | 2.608 | 1.06 |
| Example 3-1 | 44.31 | 1.137 | 14.71 | 2.789 | 2.621 | 1.06 |
| Example 3-2 | 44.68 | 1.082 | 14.23 | 2.789 | 2.621 | 1.06 |
| Example 3-3 | 45.83 | 1.17 | 13.2 | 2.789 | 2.621 | 1.06 |
| Example 4-1 | 41.51 | 0.643 | 15.54 | 2.789 | 2.621 | 1.06 |
| Example 4-2 | 46.06 | 0.573 | 13.15 | 2.789 | 2.621 | 1.06 |
| Example 4-3 | 47.32 | 1.223 | 18.56 | 2.809 | 2.642 | 1.06 |
| Example 4-4 | 48.26 | 1.174 | 18.02 | 2.819 | 2.649 | 1.06 |
| Example 4-5 | 45.67 | 0.741 | 15.87 | 2.789 | 2.621 | 1.06 |
| Example 5-1 | 44.46 | 1.363 | 16.54 | 2.789 | 2.621 | 1.06 |
| Example 5-2 | 44.76 | 1.352 | 16.36 | 2.789 | 2.621 | 1.06 |

TABLE 4

| | | | | | Rebound |
|---|---|---|---|---|---|
| | | | | | rate of |
| | 600 T | | 600 T | Weight | electrode |
| | capacity | | cycling | energy | plate in |
| | retention | Battery | expansion | density | 50% SOC |
| Group | rate (%) | appearance | rate (%) | (Wh/Kg) | state (%) |
| Example 1 | 83.26 | No | 8.71 | 292.73 | 35.16 |
| | | abnormality | | | |
| Compar- | 77.34 | Body pitting | 18.56 | 293.88 | 37.21 |
| ative | | | | | |
| example 1 | | | | | |
| Compar- | 78.6 | Severe gas | 25.64 | 286.33 | 36.98 |
| ative | | evolution | | | |
| example 2 | | | | | |
| Compar- | 79.11 | Body pitting | 16.55 | 293.49 | 36.99 |
| ative | | | | | |
| example 3 | | | | | |
| Compar- | 75.77 | Body pitting | 17.68 | 272.51 | 35.33 |
| ative | | | | | |
| example 4 | | | | | |
| Example | 80.46 | Body | 12.95 | 293.92 | 36.22 |
| 2-1 | | thickening | | | |
| Example | 82.75 | No | 9.04 | 291.89 | 35.34 |
| 2-2 | | abnormality | | | |
| Example | 82.28 | No | 9.41 | 290.24 | 35.64 |
| 2-3 | | abnormality | | | |
| Example | 79.63 | Body | 11.59 | 289.63 | 35.98 |
| 2-4 | | thickening | | | |
| Example | 73.53 | Severe gas | 22.63 | 292.53 | 38.93 |
| 3-1 | | evolution | | | |
| Example | 79.18 | Body | 12.36 | 291.94 | 35.48 |
| 3-2 | | thickening | | | |
| Example | 78.49 | Body pitting | 15.65 | 292.66 | 37.33 |
| 3-3 | | | | | |
| Example | 77.38 | Slight gas | 19.25 | 287.89 | 36.49 |
| 4-1 | | evolution | | | |
| Example | 79.32 | Body pitting | 14.02 | 294.3 | 37.72 |
| 4-2 | | | | | |
| Example | 81.56 | No | 10.47 | 295.37 | 38.52 |
| 4-3 | | abnormality | | | |
| Example | 80.12 | Body | 13.86 | 295.95 | 39.07 |
| 4-4 | | thickening | | | |
| Example | 79.83 | Body | 14.34 | 293.09 | 36.88 |
| 4-5 | | thickening | | | |
| Example | 80.96 | No | 10.26 | 283.48 | 35.39 |
| 5-1 | | abnormality | | | |
| Example | 81.70 | No | 9.65 | 296.13 | 35.29 |
| 5-2 | | abnormality | | | |

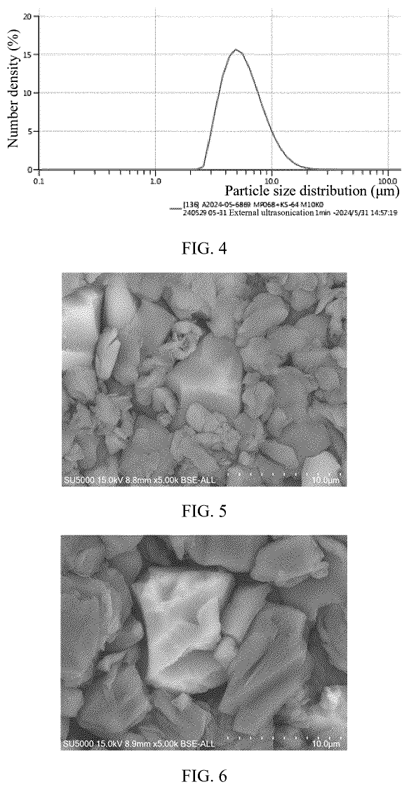

Compared to Example 1, the compositions of the negative electrode active materials of Comparative example 1 and Comparative example 2 are 20% of the silicon-carbon particles matched with 80% of first graphite particles having a large particle size and 80% of second graphite particles having a small particle size, respectively, wherein the number particle size distribution curve of the first graphite particles in Comparative example 1 is shown in FIG. 4, and the number particle size distribution of the first graphite particles having a large particle size in Comparative example 1 shows a normal distribution, Dn50=5.408 μm and Dv50=9.478 μm.

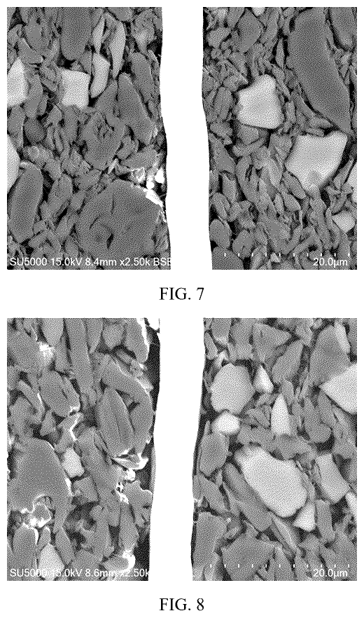

The SEM (×5 K) images of the surfaces of the negative electrode plates after rolling in Example 1 and Comparative example 1 are shown in FIGS. 5 and 6, respectively; the second graphite particles having a small particle size are incorporated in example 1; it can be seen that the gaps between the middle silicon-carbon particles and the surrounding first graphite particles having a large particle size are filled with a larger number of second graphite particles having a small particle size, and the contact between the graphite particles and the silicon-carbon particles becomes closer. Whereas no second graphite particles having a small particle size are incorporated in Comparative example 1, and it can be found that there are a large number of gaps between the graphite particles and the silicon-carbon particles.

The SEM images (×2.5 K) of the CP cross section of the negative electrode plates after rolling in Example 1 and Comparative example 1 are shown in FIGS. 7 and 8, respectively, and the contact between the particles is observed from the cross section of the electrode plates, and the results are consistent with that in the SEM images of the surface.

The porosities of the negative electrode plates in Example 1, Comparative Example 1 and Comparative example 2 are 44.24%, 46.24% and 41.46%, respectively. The results show that the incorporation of the second graphite particles having a small particle size can reduce the porosity of the negative electrode plate and reduce the pore area between the active materials.

The powder compacted densities at a pressure of 5 tons (MD-5T) of the graphites in Example 1, Comparative example 1 and Comparative example 2 are 1.719 g/cm³, 1.757 g/cm³ and 1.568 g/cm³, respectively, and the weight energy densities (WED) of the batteries are 292.73 Wh/Kg, 293.88 Wh/Kg, and 286.33 Wh/Kg, respectively; compared to the first graphite particles having a large particle size, the powder compacted density of the second graphite particles having a small particle size is significantly reduced, which is not conductive to designing a higher compacted density for the negative electrode, leading to a low energy density of the battery. In addition, under a higher incorporation of the silicon-carbon particles, the powder compacted density of the mixed active material further decreases; due to the low elastic modulus of the silicon-carbon particles, significant breakage occurs under a high rolling compaction, leading to a deterioration in overall cycling performance of the battery; therefore, incorporating graphite having a small particle size in graphite having a large particle size will also reduce MD-5T, and the reduction will be greater with the increase of the incorporating proportion.

The peel strengths between the negative electrode active material layers and the negative electrode current collectors of Example 1, Comparative example 1 and Comparative example 2 arc 1.384 gf/mm, 0.504 gf/mm, and 0.585 gf/mm, respectively, and the rebound rates of the electrode plates in a 50% SOC state are 35.16%, 37.21% and 36.98%, respectively; incorporating an appropriate amount of the second graphite particles having a small particle size in the first graphite particles having a large particle size can effectively increase the peel force of the negative electrode plate, indicating that the adhesion between the graphite particles and the silicon-carbon particles is stronger, which effectively inhibits the expansion of the negative electrode plate.

The battery was tested for cycling performance at a charge rate of 2C and a discharge rate of 4C under a constant temperature environment of 25° C.; the capacity retention rates after 600 T cycles of Example 1, Comparative example 1 and Comparative example 2 are 83.26%, 77.34% and 78.60%, respectively, and the expansion rates after 600 T cycles are 8.71%, 17.56% and 25.64%, respectively; and the corresponding appearance states of the battery after 600 T cycles are no abnormality, body thickening and gas evolution, respectively. Regardless of whether the negative electrode uses only the first graphite particles having a large particle size matched with 20% of the silicon-carbon particles, or only the second graphite particles having a small particle size matched with 20% of the silicon-carbon particles, the batteries using these electrodes all exhibit a rapid capacity decay after 600 T cycles, and the appearances of the batteries also show deformation due to excessive expansion of the batteries. By incorporating 10% of the second graphite particles having a small particle size in the first graphite particles having a large particle size, the cycling capacity retention rate is significantly improved, the expansion is significantly reduced, and the appearance of the battery shows no abnormality.

In Example 2-1, the incorporating proportion of the second graphite particles is 4%, and the capacity retention rate and expansion rate after 600 T cycles of the battery are 80.46% and 12.95%, respectively; compared to Comparative example 1, the cycling capacity retention rate and expansion are both improved. However, the appearance of the battery is still deformed, indicating that when the incorporating amount of the second graphite particles having a small particle size is too small, gaps between the graphite having a large particle size and silicon-carbon particles can not be effectively filled, and the adhesion between the particles is reduced. Therefore, as cycling proceeds, the conductive network inside the electrode plate will be slowly affected in the process of continuous expansion and contraction of the particles, resulting in body thickening of battery in the electrode plate.

The incorporating proportions of the second graphite particles having a small particle size in Examples 2-2, 2-3 and 2-4 are 16%, 24% and 32%, respectively; compared to Example 1, the cycling performances of examples 2-2 and 2-3 are comparable. However, both the energy density and powder compacted density of the battery are somewhat reduced. However, the cycling performance of Example 2-4 is deteriorated, and the appearance of the battery is deformed, indicating that an excessive incorporating proportion of the second graphite particles having a small particle size will deteriorate the cycling performance of the battery.

Compared to Example 1, the capacity retention rate of the battery in Example 3-1 using small-particle-size silicon-carbon particles (Dv50=4.994 μm) is reduced, and the appearance of the battery also exhibits gas evolution. The smaller the particle size of the silicon-carbon particles, the larger the specific surface area, which makes more SEI film formed on the surface of the silicon-carbon particles while also aggravating the side reactions between silicon and the electrolyte, resulting in gas evolution of the battery during cycling. The cycling capacity retention rate in Example 3-2 using silicon-carbon particles (Dv50=7.220 μm) is improved, but the appearance of the battery exhibits body thickening.

Compared to Example 1, large-particle-size silicon-carbon particles (Dv50=11.59 μm) are used in Example 3-3, and the capacity retention rate becomes worse and the expansion becomes larger after 600 T cycles; large-particle-size silicon-carbon particles is more prone to breakage under the same pressure, consequently deteriorating the cycling performance of the battery.

Compared to Example 1, the first graphite particles in Example 4-1 is replaced with graphite having a smaller particle size (Dv50=6.062 μm, Dn50=1.052 μm), and the second graphite particles in Example 4-2 is replaced with graphite having a larger particle size (Dv50=6.062 μm, Dn50=1.052 μm). The cycling performances of the batteries of both the examples are deteriorated, and the batteries also exhibit varying degrees of deformation.

The preferred embodiments of the present disclosure have been described in detail above; however, the present disclosure is not limited thereto. Within the technical concept of the present disclosure, various simple modifications can be made to the technical solution of the present disclosure, including the combination of various technical features in any other suitable way. These simple modifications and combinations should also be regarded as the content disclosed by the present disclosure and all fall within the scope of protection of the present disclosure.

What is claimed is:

1. A battery, comprising:
a positive electrode plate; and
a negative electrode plate, wherein
the negative electrode plate comprises a negative electrode current collector and a negative electrode active material layer located on a surface on at least one side of the negative electrode current collector;
the negative electrode active material layer comprises a negative electrode active material, wherein the negative electrode active material comprises graphite particles and silicon-carbon particles, and the graphite particles comprise first graphite particles and second graphite particles, wherein a particle size Dv50 of the first graphite particles is greater than that of the second graphite particles;
the positive electrode plate comprises a positive electrode active material, wherein the positive electrode active material comprises a material with a chemical formula of LiₐNiₓCo_{y}Mn_{z}MₖO₂, where 0.8≤a≤1.2, 0.8≤x≤0.95, 0<y<0.2, 0<z<0.2, 0≤k≤0.05, and M comprises at least one of Al, Mg, Zr, B, Y, Sr, W, La, Ti, and Nb.

2. The battery according to claim 1, wherein a content of element Si in the negative electrode active material layer is C_{Si};
the negative electrode active material layer comprises at least one of elements Ni, Co and Mn, and in the negative electrode active material layer, a content of element Ni is C_{Ni}, a content of element Co is C_{Co}, and a content of element Mn is C_{Mn};
and C_{Si}, C_{Ni}, C_{Co} and C_{Mn} satisfy: 10≤C_{Si}×C_{Ni}/(C_{Co}+C_{Mn})≤20.

3. The battery according to claim 2, wherein 10.8≤C_{Si}×C_{Ni}/(C_{Co}+C_{Mn})≤18.6;
preferably 13≤C_{Si}×C_{Ni}/(C_{Co}+C_{Mn})≤16;
and/or, C_{Si} is 4%-36%; preferably 5%-15%;
and/or, C_{Ni} is 50 ppm-150 ppm; preferably 90 ppm-120 ppm;
and/or, C_{Co} is 30 ppm-100 ppm; preferably 50 ppm-70 ppm;
and/or, C_{Mn} is 2 ppm-15 ppm.

4. The battery according to claim 1, wherein a number particle size distribution curve of the second graphite particles has two characteristic peaks in a range of 0 μm-10 μm, where a first characteristic peak is located at 0.5 μm-2 μm, and a second characteristic peak is located at 3 μm-6 μm;
and/or, a particle size Dv50 of the first graphite particles is 5 μm-15 μm, a particle size Dv50 of the second graphite particles is 2 μm-8 μm, and the particle size Dv50 of the silicon-carbon particles is 6 μm-13 μm;
and/or, a particle size Dn50 of the first graphite particles is 3 μm-12 μm, a particle size Dn50 of the second graphite particles is 0.5 μm-2 μm, and the particle size Dn50 of the silicon-carbon particles is 4 μm-10 μm.

5. The battery according to claim 1, wherein the particle size Dn50 of the first graphite particles is D1, the particle size Dn50 of the second graphite particles is D2, and a particle size Dn50 of the graphite particles is D3;
D1, D2 and D3 satisfy: 0.3≤D3/(D1+D2)≤0.5; and
the particle size Dv50 of the graphite particles is D4, and the particle size Dv50 of the silicon-carbon particles is D5; D4 and D5 satisfy: 0.88≤D4/D5≤1.12;
preferably 0.35≤D3/(D1+D2)≤0.45, 0.94≤D4/D5≤1.06.

6. The battery according to claim 5, wherein a mass content of the silicon-carbon particles in the negative electrode active material is 10%-60%; preferably 20%-40%;
and/or, a content of element Si in the silicon-carbon particles is 40%-60%; preferably 45%-55%;
and/or, the particle size Dn50 of the graphite particles is 0.5 μm-15 μm, and the particle size Dv50 of the graphite particles is 3 μm-18 μm; preferably the particle size Dn50 of the graphite particles is 2 μm-10 μm, and the particle size Dv50 of the graphite particles is 6 μm-12 μm;
and/or, the silicon-carbon particles have a core-shell structure, a core of the core-shell structure comprises porous carbon and silicon located in the pores of the porous carbon, and a shell of the core-shell structure comprises a carbon material;
and/or, an average sphericity of the silicon-carbon particles is 0.5-0.9.

7. The battery according to claim 1, wherein a powder compacted density of the graphite particles at a pressure of 5 tons is 1.6 g/cm³-2 g/cm³;
and/or, a porosity of the negative electrode active material layer is 30%-50%;
and/or, a peel strength between the negative electrode active material layer and the negative electrode current collector is 0.5 gf/mm-2 gf/mm;
and/or, an OI value of the negative electrode active material layer is 10-25;
and/or, at least part of the second graphite particles are located in gaps between the first graphite particles and the silicon-carbon particles.

8. The battery according to claim 1, wherein the positive electrode plate comprises a positive electrode current collector and a positive electrode active material layer located on a surface on at least one side of the positive electrode current collector; a capacity per unit area of the positive electrode active material layer is Q1, a capacity per unit area of the negative electrode active material layer is Q2, and Q1 and Q2 satisfy: 1<Q2/Q1≤1.15;
and/or, Q1 is 1 mAh/cm²-5 mAh/cm², and Q2 is 1 mAh/cm²-5.8 mAh/cm².

9. The battery according to claim 1, wherein the particle size Dv50 of the positive electrode active material is 1 μm-10 μm;
preferably the positive electrode active material comprises single-crystal particles.

10. The battery according to claim 1, wherein the battery further comprises an electrolyte containing 2,2-difluoroethyl acetate, wherein a mass content of the 2,2-difluoroethyl acetate in the electrolyte is C₁, a content of element Si in the negative electrode active material layer is C_{Si}, and C₁ and C_{Si} satisfy: 0.3≤C₁/C_{Si}≤3.5; preferably 1.5≤C₁/C_{Si}≤2.5.
